(19) United States
(12) Patent Application Publication
(10) Pub. No.: US 2023/0153777 A1
(43) Pub. Date: May 18, 2023

(54) Multilateral Online Book Transaction System

(71) Applicant: Jinghua DING, Beijing (CN)

(72) Inventor: Jinghua DING, Beijing (CN)

(21) Appl. No.: 17/919,271

(22) PCT Filed: Apr. 13, 2021
(86) PCT No.: PCT/CN2021/087030

§ 371 Date: Oct. 16, 2022

(30) Foreign Application Priority Data
Apr. 15, 2020 (CN) 202010293956.0

(51) Int. Cl. G06Q 20/12; G06Q 30/0601; G06Q 50/26

(52) U.S. Cl. CPC G06Q 20/1235; G06Q 30/0631; G06Q 50/26

(57) ABSTRACT

A multilateral online book transaction system is a client-server system whose server is built up with a database layer and a business layer. The database layer comprises of a plurality of electronic book files and book transaction information. The business layer comprises at least four partners with four different services. The four partners comprise of book readers, book publishers, library administrators and bookstore managers. The server is configured to receive media files of the books from the publishers. The server is further configured to analyze the media files of the books to generate accessory files and store both media files and accessory files in the database. The server is further configured to forbid the book readers to download the book media files to their own machines but enable the at least one book reader with the functions to search books, read pages, search full-text of a book, write memorandum, and be charged on a per page basis.

### TECHNICAL FIELD

The present invention relates in general to book transaction systems. More particularly, the present invention relates to a unique multilateral online book transaction system configured to allow book readers to access any book to be read precisely to a page or even a keyword, and allow book publishers to distribute the books by simply uploading the book media files to the server, as well as forbid the book readers to download the book media files to their own machines.

### TECHNICAL BACKGROUND

The present invention is a set of online book transaction system that serves multiple partners based on the technologies of client-server system, database, network, Java, and smart mobile devices. Currently, there are two types of books on the market: traditional paper book and electronic book. Either of them has its own advantages and disadvantages for book reading and book distribution.

(1) For the Traditional Paper Book Transaction

Advantages: With a paper book in hands, the book readers could freely leaf through the whole book at the bookstore. It is convenient and efficient for the book readers to make decision on purchasing a book,

Disadvantages: It is impossible to search full-text of a paper book to quickly locate targets, which can be done with the electronic books. And the number of the paper books is very limited by the scale of the traditional bookstore.

(2) For the Electronic Book Transaction

Advantages: There could be unlimited number of ebooks in the online bookstore and it is very easy to search full-text of an ebook to quickly locate targets.

Disadvantages: Before an electronic book is bought and downloaded, the book readers cannot freely leaf through the content of the ebook as they can with the paper books at the traditional bookstore, which makes it uneasy for the book readers to make decision on purchasing a book. Besides, once an ebook is bought, the downloaded ebook file results in the problem of piracy, which has been annoying the ebook distribution. Hence, it is very clear and evident from above that the current online book transaction systems are not able to effectively provide feature of the easy access of any book to be read by the book reader, as well as forbid any book reader or user to download the book media files to their own machines. Hence, there is a need for a system which is configured to allow book readers to access pages of any book to be read, as well as forbid the book readers to download the book media files to their own machines.

### Technical Solution

Based on a database that stores the electronic books, this invention sets up a client-server system of the online multilateral book transaction for book reading and book distribution.

At the server side, a database layer is built at the bottom and a business layer, which provides the four partners with four different services, is built at the top. The four partners include the book readers, the book publishers, the library administrators and the bookstore managers. The server receives the book media files in PDF format from the publishers, analyzes them to generate accessory files, and stores both media files and the accessory files in the database. When a reader searches or reads a book, the server checks the information of the book and the information of the reader account (and sometimes affiliated library information of the reader) to response the reader's request. The server also provides the real-time book selling information or the book reading information for the four partners respectively.

At the client side, all partners visit the bookstore by hooking their desktops or smart mobile devices to the internet. For the book readers, the core tech is an electronic book reader app. An essential data storage is built at the bottom to analyze PDF components of the book media files. At its top, by using different programming languages, an adaptive layer is created for different reader platforms to communicate with the server. At the client side, the book reader app provides the book readers with the function to search books, read pages, search full-text of a book, and be charged on a per page basis. Meanwhile, the client-side app for the publishers is implemented to upload the book PDF files and other basic book transaction information such as per page price to the server. And the client-side app for the libraries is implemented to manage the library bookshelf and the library users. The libraries are actually to serve different book reader groups. They are charged either according to the total number of the read pages of the library users or according to the total number of the books bought in advance. At last, the client-side app for the bookstore managers is mainly to put on/take off books and recommend the books, the authors, the publishers and the libraries.

As a whole, this client-server system provides four partners with four services, including book reading service for the book readers, book distribution service for the publishers, management service for the libraries, and management service for the bookstore managers.

### Advantageous Effects

While this multilateral online book transaction system avoids the disadvantages of both the paper books and the electronic books, it has all their advantages: The book readers could leaf through the whole book freely before making decision to buy it; The problem of the book privacy is radically evaded by forbidding the book media files to be downloaded; The function of the full-text search makes the book reading highly efficient; The high resolution of the page based on PDF files provides readers with delicate pages, which brings extremely enjoyable reading experience; The number of the books in the bookstore could be unlimited; And the two methods to charge the library makes the brand new style library efficient and convenient.

### BRIEF DESCRIPTION OF DRAWINGS

FIG. 1 is a block diagram illustrating structure of an online book transaction system;

FIG. 2 is a block diagram illustrating workflow of the online book transaction system;

FIG. 3 is a block diagram illustrating relationship between the book readers and the bookstore server;

FIG. 4 is a block diagram illustrating the relationship between the book publishers and the bookstore server; and

FIG. 5 is a block diagram illustrating the relationship between the libraries and the bookstore server.

### DETAILED DESCRIPTION OF DRAWINGS

### 1. Outline

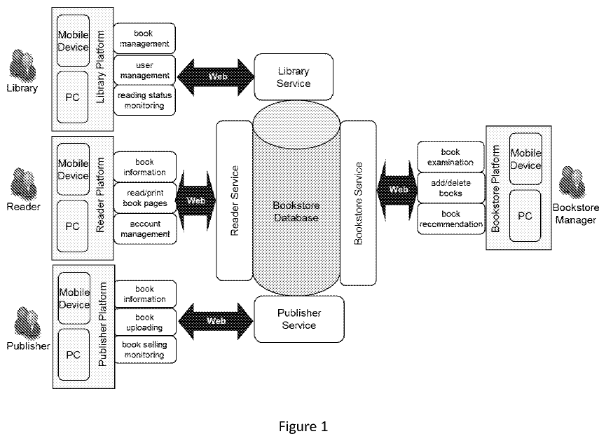

The structure of this multilateral book transaction system (shown in FIG. 1) sets up a client-server system for online book reading and online book distribution involving the technology of database, network, Java and mainstream smart mobile devices. At the bottom of the bookstore server is a database of the electronic book files and the book transaction information. Above the database are business layers serving four partners respectively. Service for the book readers includes book search, book reading/print, book full-text searching, and book reader account management. Service for the book publishers includes book distribution, real-time book selling status monitoring and publisher account management. Service for the book library administrators includes the library book management, the library user management and the library online book reading status monitoring. Service for the bookstore managers includes the functions to put on/take off books and the functions to recommend books, authors, publishers and libraries.

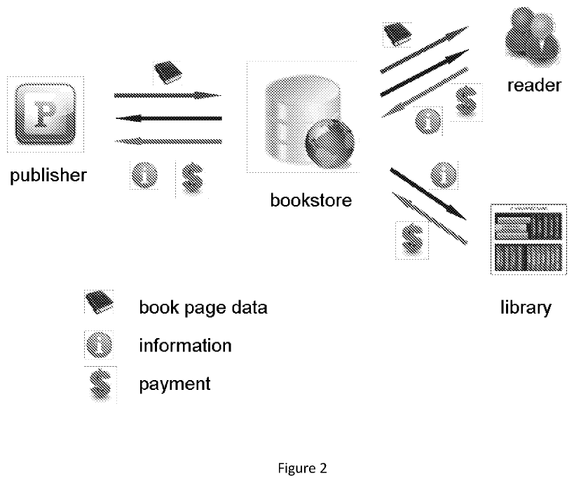

The data flows in the system are shown in FIG. 2. First, publishers upload book PDF files to the bookstore. If any error is found by the bookstore managers, publishers will be noticed to correct the error and upload the file again. After the book is accepted by the store, readers can read/print the book in PDF format on different types of platform, from the smart mobile devices to the mainstream desktops, and pay the book content page by page. The all-around service requires readers to open an account and deposit certain amount of money. If the reader is a member of library, and the library has that book, then the cost of the page is paid by the library. Readers can not only search books and manage their own bookshelf, but also search full-text of a book, make notes, write comments, and so on. Publishers are able to check the real-time book selling status precise to the book pages read by the readers. Library administrators may mange the library user accounts and library book collection, check users' reading records, and monitor the reading status of the library collection precisely to the page of a book. Bookstore managers (not indicated in this graph) could put the book on or take the book off the bookshelf of the store, and recommend books, authors and so on.

### 2. Book Reading Service for the Book Readers

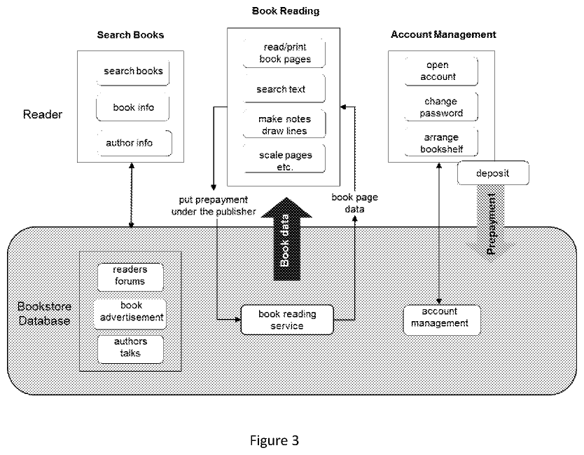

An all-around electronic book reader app is uniquely invented for the book readers. Based on a PDF resolver, different platform languages are used for different type of devices to furnish the same human-machine interaction. Book readers could enjoy the delicate pages just like a paper book and scale the pages without any quality loss. Readers are charged on a per page basis. They need not buy the whole book for only parts of book contents that is really necessary. Once the reader has read a page, his account will be noted and the reader can access that page again without being charged again. It also allows readers to print individual pages of a book for a per page fee. When the book can be only accessed through the website, the book page data can never be actually saved on the readers' devices so that the publisher's book copyright is thoroughly protected. This electronic book reader app also provides readers with the function of full-text search through the whole book to quickly locate targets. It also provides readers with functions of electronic memorandum such as making notes, drawing lines and so on. Readers can also let their friends obtain their own notes, which may become a powerful tool for the teacher-student communication. Traditional functions, such as looking for books and managing bookshelves, are also included. The reader app can be downloaded and installed on different types of mainstream machines, either the smart mobile devices or the personal desktops. The relation between the book readers and the bookstore server is shown in FIG. 3.

### 3. Book Distribution Service for the Publishers

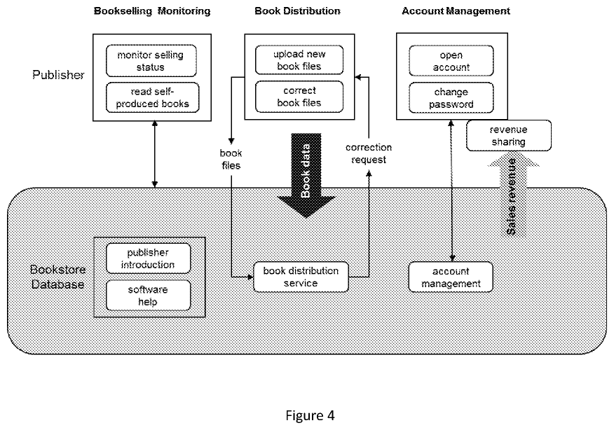

The book distribution service for the publishers is an efficient, cost-effective, and convenient distribution channel for the publishers. Publishers can make a book go publish at the very first time once the book media file is ready. The page price for online reading of a book and the maximum cost for a book are determined by the publishers. In order to drum up the readers' interest to purchase the entire book, publishers also have the option to give parts of their books for free or set the maximum number of pages free of charge. They can also decide whether or not print a seal on each page shown on screen to further forbid piracy through the screen shot. Because the book readers cannot save the book media file on their own machine, book copyright is thoroughly protected. While a set of real-time monitoring tool on the book selling status is detailed to a book page, publishers can grab demographics on which book readers are reading which titles, and how many books and pages the readers are reading for each day, each week, each month, or even each year. Such a channel may help publishers easily predict a book's market potential. The relation between the publishers and the bookstore server is shown in FIG. 4.

### 4. Management Service For the Libraries

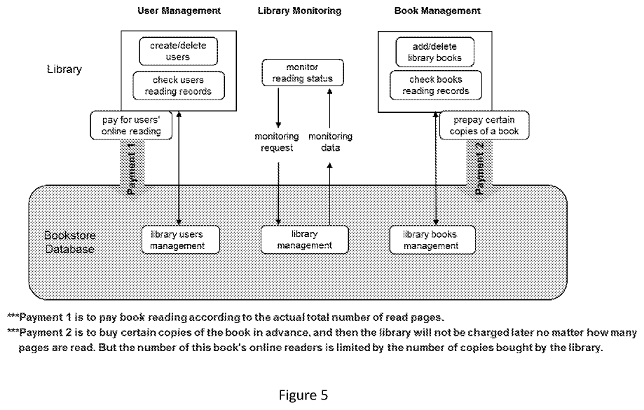

The system provides the libraries with efficient service to manage the books and the users of the library. Libraries need not the storage of the book media files. They only need to choose books, and then pay the book reading in two ways: (1) Pay the book reading according to the actual total number of pages read by the library users (Payment 1 in FIG. 5); (2) Buy certain copies of the book in advance, and then the library will not be charged later no matter how many pages are read by the library users (Payment 2 in FIG. 5). But the member of the online users of the bought book is limited by the number of the book copies bought by the library. Libraries could monitor the online reading status focused on a book, or focused on a library user. The library administrator could add/delete either the users or the books. The library user management and the book collection management are the main task of the service for the libraries. The relation between the libraries and the bookstore server is shown in FIG. 5.

### 5. Management Service for the Bookstore

The main task of the bookstore managers is to manage books of the bookstore and manage the accounts of the book readers, the book publishers and the book libraries. The bookstore managers could read the books uploaded by the publishers and check them. If no problem is found, the book will be put on the bookshelf of the store to start the sale immediately. Otherwise, the publisher will be noticed to correct the errors. Bookstore manager can also monitor the book selling status and check the book reading status as the publishers and the libraries.

1. A multilateral online book transaction system is a client-server system comprising:
a database layer of a server comprising a plurality of electronic book files and a transaction information;
a business layer of a server comprising at least four partners with four different services, wherein the four partners comprises of book readers, book publishers, library administrators and bookstore managers; and
a server built up with the database layer and the business layer, wherein the server is configured to:
receive media files of the books from the publishers,
compute information of at least one book and information of a reader account to response to request of at least one book reader, while the at least one book reader searches or reads the at least one book;
enable the at least one book reader with the function to search books, read pages, search full-text of a book, write memorandum, and be charged on a per page basis, based on the computed information of the at least one book and the computed information of the reader account.

2. The multilateral online book transaction system of claim 1, wherein the server is further configured to provide the real-time book selling information or the book reading information respectively for the at least four partners.

3. The multilateral online book transaction system of claim 1, wherein the system further comprises at least four client applications configured to enable the at least four partners to visit a bookstore by hooking their personal desktops or smart mobile devices to the internet.

4. The multilateral online book transaction system of claim 3, wherein the client application is configured to be implemented to upload the book PDF files and other book information like per page price to the server, by the publishers.

5. The multilateral online book transaction system of claim 3, wherein the client application is configured to be used in libraries, and implemented to manage the library bookshelf and the library users,

6. The multilateral online book transaction system of claim 3, wherein the client application is configured to be used by the bookstore managers to put on/take off books and recommend the books, the authors, the publishers and the libraries.

7. The multilateral online book transaction system of claim 3, wherein the client application is configured to be used by the book readers to search books, read pages, search the full-text of the book, write memorandum, and be charged on the per page basis.

8. The multilateral online book transaction system of claim 1, wherein any of at least four applications further comprises an adaptive layer created for different reader platforms of the clients to communicate with the server.
